(19) United States
(12) Patent Application Publication
(10) Pub. No.: US 2024/0181973 A1
(43) Pub. Date: Jun. 6, 2024

(54) VEHICLE HEADLINER HAVING HEAT INSULATING FUNCTION

(71) Applicant: DAEHAN SOLUTION CO., LTD, Incheon (KR)

(72) Inventors: Choong Ho KWON, Seoul (KR); Ho-Young JEOUNG, Incheon (KR)

(73) Assignee: DAEHAN SOLUTION CO., LTD, Incheon (KR)

(21) Appl. No.: 18/517,610

(22) Filed: Nov. 22, 2023

(30) Foreign Application Priority Data
Dec. 6, 2022 (KR) 10-2022-0168675

(51) Int. Cl. B60R 13/02; B32B 5/02; B32B 5/24; B32B 7/12

(52) U.S. Cl. CPC B60R 13/0212; B32B 5/022; B32B 5/245; B32B 7/12; B32B 2266/0278; B32B 2605/003

(57) ABSTRACT

When a non-woven fabric is attached to a surface of a polyurethane foam sheet, an aluminum film is inserted between and integrally formed with the non-woven fabric and polyurethane foam sheet so that an increase in weight of a headliner is minimized, and a temperature of a vehicle interior is lowered by about 1.6° C. as compared to a case of attaching a non-woven fabric using a hot melt film through a heat insulating function of the headliner, thereby providing a comfortable internal environment. In particular, the aluminum film coated with an adhesive is used to easily integrally attach the polyurethane foam sheet and the non-woven fabric to manufacture the headliner and lower the temperature of the vehicle interior through the heat insulating function. In addition, the aluminum film is attached to both surfaces of the polyurethane foam sheet and integrally manufactured with the polyurethane foam sheet so that a heat insulating effect is achieved twice, and thereby effectively insulating heat being transferred to the vehicle interior so as to form a comfortable internal environment.

### CROSS-REFERENCE TO RELATED APPLICATION

This application claims priority to and the benefit of Korean Patent Application No. 10-2022-0168675, filed on Dec. 6, 2022, the disclosure of which is incorporated herein by reference in its entirety.

### BACKGROUND

### 1. Field of the Invention

The present invention relates to a vehicle headliner having a heat insulating function, and more specifically, to a vehicle headliner having a heat insulating function, in which, when non-woven fabrics are attached to both surfaces of a polyurethane foam sheet, aluminum films are used to integrally attach the non-woven fabrics to insulate external heat being transferred into a vehicle and lower an indoor temperature so as to form a comfortable internal environment.

### 2. Discussion of Related Art

A vehicle headliner is one important interior material installed to face a roof panel in a vehicle so that external heat being transferred into the vehicle is insulated and noise blocking performance is also improved. Such a headliner is manufactured with a structure having various layers to form such a comfortable internal environment as in Patent Document 1 to Patent Document 3 below.

### (Patent Document 1) Korean Patent Publication No. 10-2022-0056271

It is directed to providing a low-weight headliner for a vehicle, in which a super fiber layer is used as a fiber layer for sound absorption and the like to lower a weight of the headliner and improve the fuel efficiency of a vehicle without degrading sound absorption performance. In particular, it is also directed to proving a low weight headliner for a vehicle, in which, as a super fiber layer formed of at least one of carbon fiber, aramid fiber, and polyphenylene sulfide fiber (PPS) is used, high strength and high heat resistance can be achieved to prevent wrinkles or deformation at high temperatures during a manufacturing process of the headliner so as to improve quality.

### (Patent Document 2) Korean Patent Publication No. 10-2019-0117938

It is directed to providing a headliner for a vehicle, in which, since the headliner is manufactured using a spunlace non-woven fabric manufactured through a physical method instead of using a chemical binder when a non-woven fabric is manufactured, volatile organic compounds (VOSs) that are harmful to the human body, such as formaldehyde that can be generated when a chemical binder is used, are not generated so that the headliner for a vehicle can used safely. In particular, it is also directed to providing a headliner for a vehicle, which is light, is hardly broken, is used safely, and secures the same strength as the existing headliner because a Polyethylene terephthalate (PET) fiber is used as a fiber used for manufacturing a spunlace non-woven fabric.

### (Patent Document 3) Korean Patent Publication No. 10-2019-0033722

In a headliner composed of a base material and a surface layer, as several vent holes are formed in the base material, and a breathable surface layer is used as the surface layer, a fluid spray function can be served without using a separate air vent grill. In particular, even when a fluid that passes through the breathable surface layer through the vent holes is sprayed directly onto a driver or passenger, a comfortable internal environment can be formed without causing discomfort. In addition, since a component for a function of the existing air vent grille is not exposed to an interior of a vehicle while serving the function, a design freedom of the headliner can be improved, and in addition, aesthetics of the headliner and a vehicle interior can be improved.

### RELATED ART

### [Patent Document]

(Patent Document 1) Korean Patent Publication No. 10-2022-0056271 (Publication date: May 6, 2022)
(Patent Document 2) Korean Patent Publication No. 10-2019-0117938 (Publication date: Oct. 17, 2019)
(Patent Document 3) Korean Patent Publication No. 10-2019-0033722 (Publication date: Apr. 1, 2019)

### SUMMARY OF THE INVENTION

However, such an existing vehicle headliner has following problems.

(1) As a headliner is installed to face a roof panel, some heat being transferred into a vehicle interior through the roof panel is transferred to the headliner and eventually transferred to the vehicle interior.

(2) The heat transferred as described above increases a temperature of the vehicle interior, thereby preventing the providence of a comfortable indoor space for a driver and passengers.

(3) In order to solve these problems, a layer structure capable of insulating heat may be manufactured separately in addition to a multi-layer structure constituting a headliner. However, this causes the following problems.

(4) As the number of layers in the structure increase, a thickness of the headliner increases, and thus space utilization in a limited vehicle interior is lowered.

(5) In addition, due to the addition of the new layer structure, a manufacturing cost increases, and in addition, an overall weight of the headliner increases. Therefore, this is a factor in a decrease in fuel efficiency of the vehicle.

The present invention is directed to providing a vehicle headliner having a heat insulating function, in which, when a non-woven fabric is integrally formed on a surface of a polyurethane foam sheet, an aluminum film is inserted between and integrally formed with the non-woven fabric and the polyurethane foam sheet so that an increase in weight of the headliner is minimized, and a temperature of a vehicle interior is lowered by about 1.6° C. as compared to a case of attaching a non-woven fabric using a hot melt film through a heat insulating function of the headliner, thereby providing a comfortable internal environment.

In particular, the present invention is also directed to providing a headliner having a heat insulating function, in which an aluminum film coated with an adhesive is used to easily integrally attach a polyurethane foam sheet and a non-woven fabric to manufacture the headliner and lower a temperature in a vehicle interior through the heat insulating function.

In addition, the present invention is also directed to providing a vehicle headliner with a heat insulating function, in which aluminum films are integrally manufactured with the polyurethane foam sheet by being attached to both surfaces of a polyurethane foam sheet so that a heat insulating effect is achieved twice, thereby effectively insulating heat from being transferred to a vehicle interior so as to form a comfortable internal environment.

According to an aspect of the present invention, there is provided a vehicle headliner having a heat insulating function, which includes non-woven fabrics (20) integrally attached to both surfaces of a polyurethane foam sheet (10), a skin member (30) attached to and integrally formed with any one of the non-woven fabrics (20) that is attached to a surface exposed to an interior, and aluminum films (21) inserted between and integrally attached to the polyurethane foam sheet (10) and the non-woven fabrics (20).

In particular, the aluminum films (21) may be coated with an adhesive.

In addition, the aluminum film (21) may be disposed on at least one surface of both surfaces of the polyurethane foam sheet (10) and integrally formed with the polyurethane foam sheet (10).

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a vehicle and shows a position at which a vehicle headliner is mounted;

FIG. 2 is a perspective view of the vehicle headliner having a heat insulating function that is manufactured according to the present invention;

FIGS. 3A and 3B are views of a layer structure of the vehicle headliner having a heat insulating function according to the present invention, wherein FIG. 3A is a view of an exploded cross-sectional structure, and FIG. 3B is a view of an integrated cross-sectional structure;

FIGS. 4A and 4B show images, wherein FIG. 4A is the image of Comparative example (a) which uses a hot melt film when a non-woven fabric is attached to a polyurethane foam, and FIG. 4B is the image of Example which uses an aluminum film according to the present invention instead of the hot melt film;

FIG. 5 is an image of a device used to measure a heat insulation of Comparative example and Example of FIG. 4; and

FIG. 6 is a graph showing a temperature change (° C.) over time (minutes) of Comparative Example and Example.

### DETAILED DESCRIPTION OF EXEMPLARY EMBODIMENTS

Hereinafter, exemplary embodiments of the present invention will be described in more detail with reference to the accompanying drawings. Moreover, terms and words used in the present specification and claims should not be interpreted as being limited to commonly used meanings or meanings in dictionaries and should be interpreted as having meanings and concepts which are consistent with the technological scope of the invention based on the principle that the inventors have appropriately defined concepts of terms in order to describe the invention in the best way.

Therefore, since the embodiments described in this specification and components illustrated in the drawings are only exemplary embodiments and do not represent the overall technological scope of the invention, it should be understood that there may be various equivalents or modifications substituting the exemplary embodiments at the time of filing of this application.

### [Structure of Vehicle Headliner Having Heat Insulating Function]

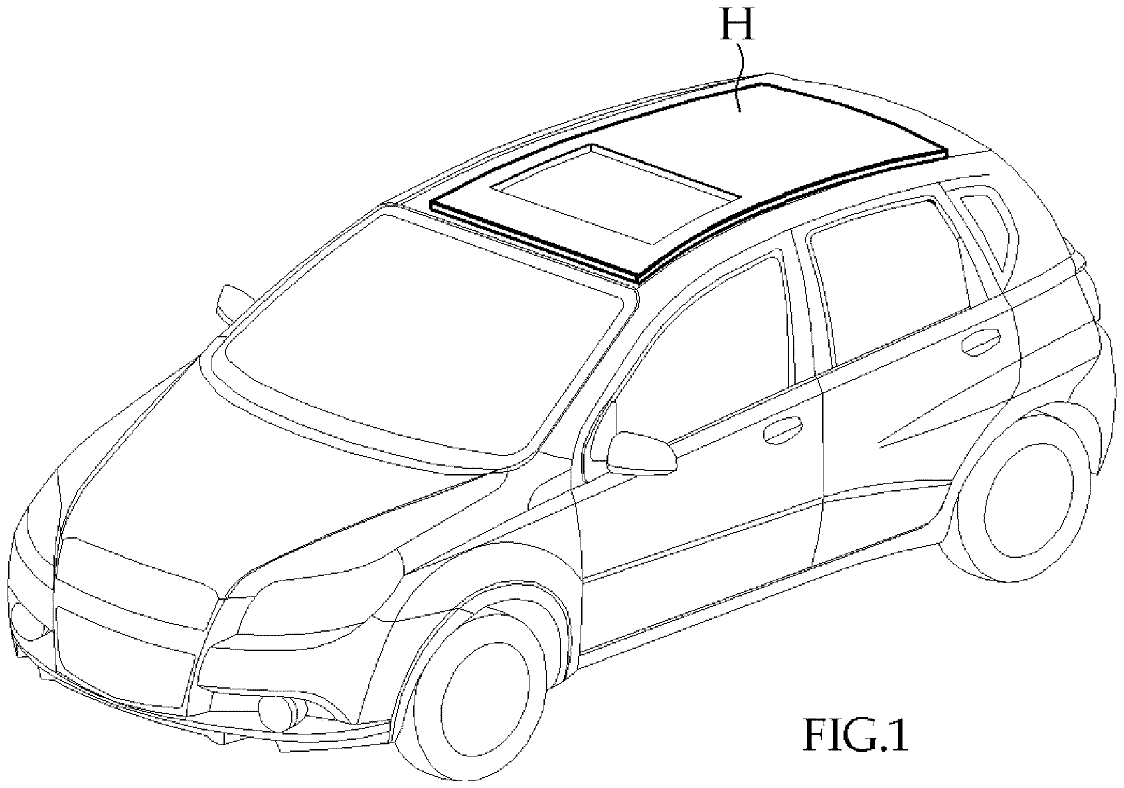

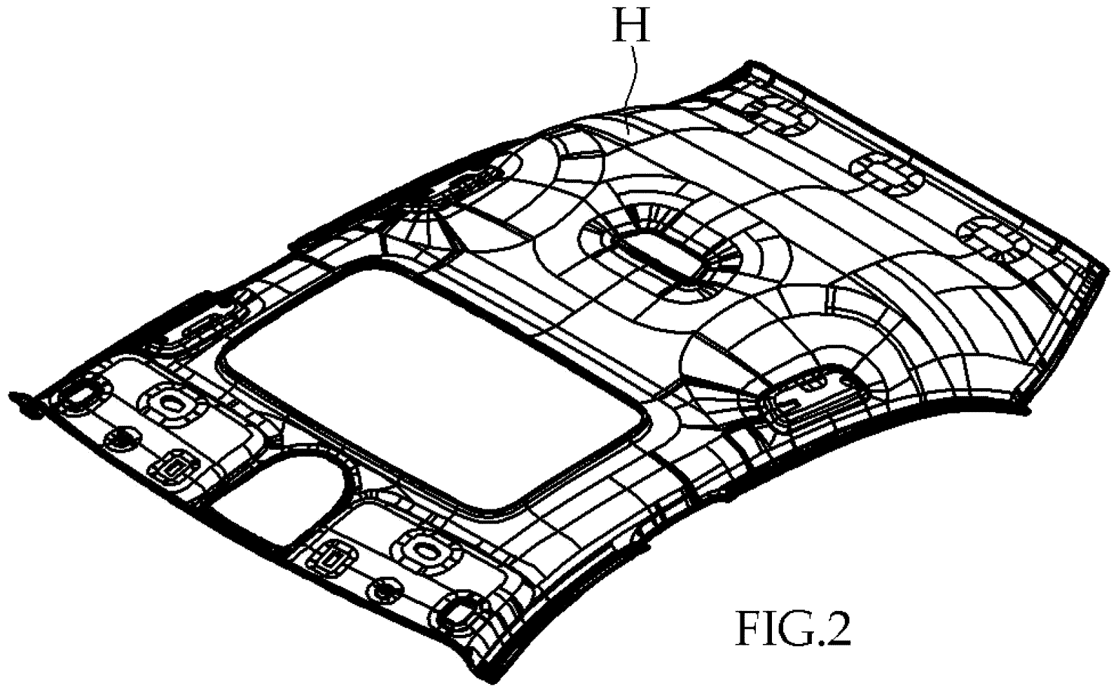

A vehicle headliner having a heat insulating function according to the present invention includes a polyurethane foam sheet 10, non-woven fabrics 20, and a skin member 30 as in FIGS. 1 to 6.

In particular, since aluminum films 21 are inserted between and integrally manufactured with the polyurethane foam sheet 10 and the non-woven fabrics 20, a glue or adhesive such as a hot melt film is not used to attach the non-woven fabrics 20, and in addition, a temperature of a vehicle interior is lowered through a heat insulating effect of aluminum so as to form a comfortable internal environment.

In this case, as the aluminum films 21 coated with an adhesive are used to integrally form the polyurethane foam sheet 10 and the non-woven fabrics 20, the headliner having a heat insulating function can be easily conveniently manufactured to have a desired shape through a thermoforming method.

In addition, as the aluminum film 21 is disposed on at least one of both surfaces of the polyurethane foam sheet 10 and integrally formed with the polyurethane foam sheet 10, the aluminum film 21 may be applied on only one surface or both surfaces of the polyurethane foam sheet 10 in consideration of heat transferred into the vehicle interior through a roof panel.

Hereinafter, such a structure will be described in more detail below with reference to the accompanying drawings.

### A. Polyurethane Foam Sheet

The polyurethane foam sheet 10 is a sheet which constitutes a middle portion of a headliner H as in FIGS. 1 to 3.

In this case, a polyurethane foam is cut into a sheet type to form the polyurethane foam sheet 10, wherein the polyurethane foam is manufactured by foaming polyurethane, which is a polymer generated by the repeated formation of a urethane group through an addition reaction between alcohol and isocyanate, using a foaming agent in a frame having a desired shape. The polyurethane foam sheet 10 may use a polyurethane foam sheet used as a sound absorbing material manufactured through the conventional technology in a technical field to which the present invention belongs.

### B. Non-woven Fabric

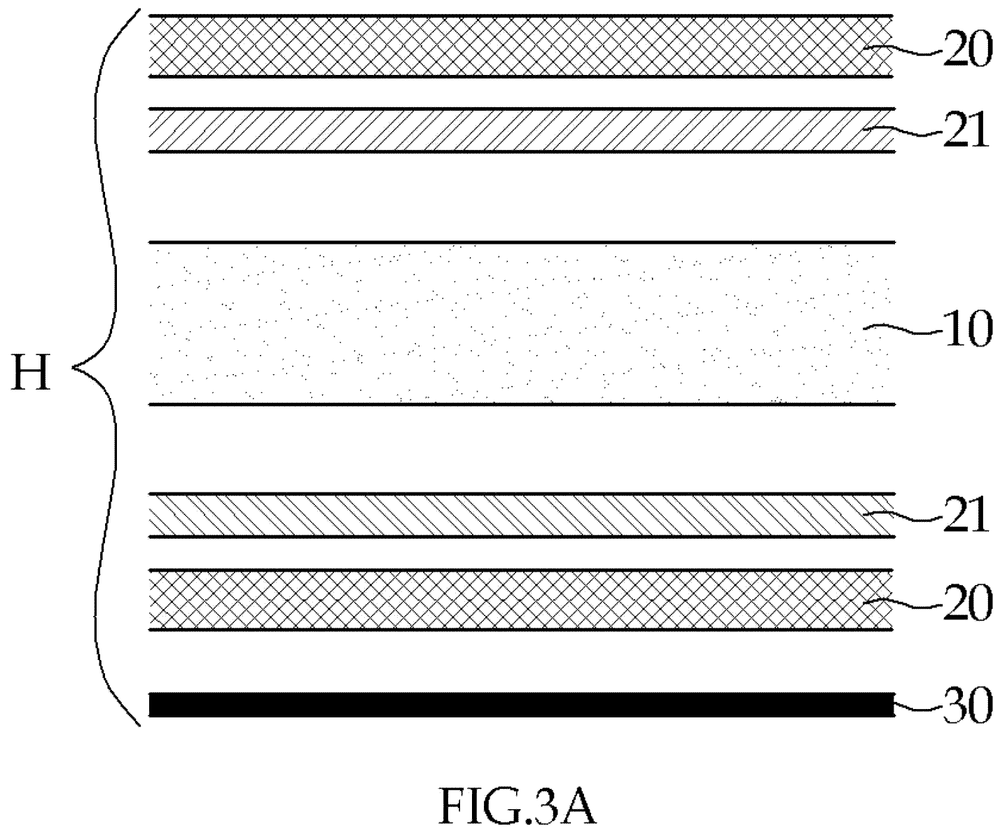

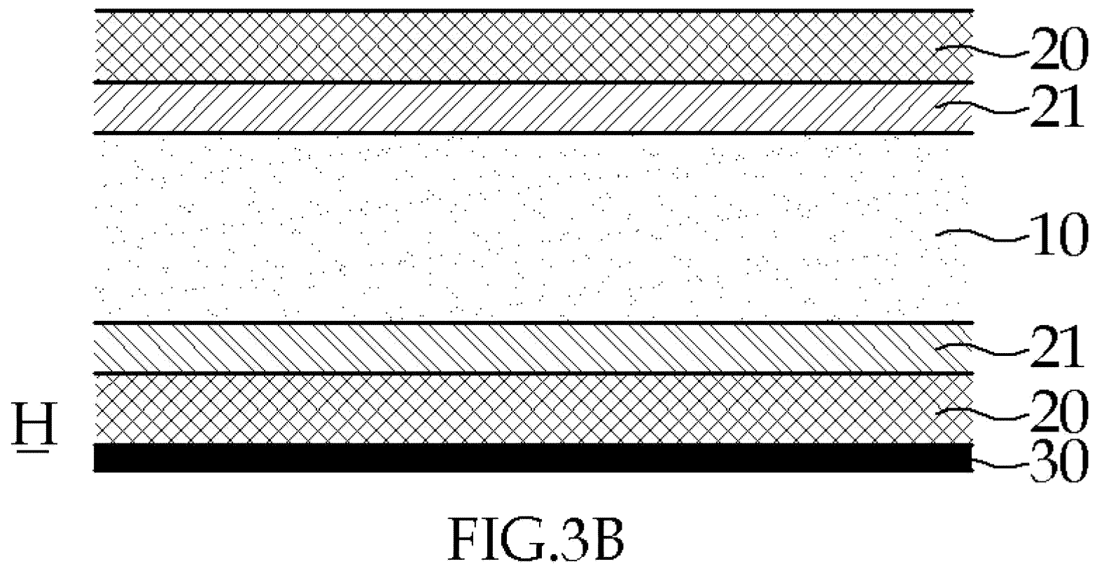

The non-woven fabric 20 is attached to each of both surfaces of the polyurethane foam sheet 10 described above as in FIG. 3.

In this case, the non-woven fabric 20 is a fabric formed by bonding or entangling fibers through a mechanical process, thermal bonding, or using chemicals. In this case, a yarn state does not occur in a fabrication process of the non-woven fabric 20, and an example of the non-woven fabric 20 may be a felt, resin-bonded non-woven fabric, needle punch, spun bond, spun lace, emboss film, or wet non-woven fabric.

In the exemplary embodiment of the present invention, any non-woven fabric which maintains an overall shape of the headliner according to the present invention and reinforces rigidity to support not to be easily bent or broken may be used as the non-woven fabric 20. In the present invention, a non-woven fabric which is used to reinforce rigidity and maintain a shape in the technical field to which the present invention belongs as described above may be used as the non-woven fabric 20.

Meanwhile, the non-woven fabric 20 is integrally formed with the polyurethane foam sheet 10 with the aluminum film 21 inserted therebetween as in FIG. 3.

### Aluminum Film

The aluminum film 21 is mounted between and integrally formed with the polyurethane foam sheet 10 and the non-woven fabric 20 as in FIG. 3.

In this case, a film manufactured by thinning aluminum is the aluminum film 21, and the aluminum film 21 allows heat being transferred through the headliner to be insulated due to a heat insulating effect of aluminum so as to prevent an increase in temperature of the vehicle interior so as to form a comfortable environment of the vehicle interior.

In this case, since the aluminum film 21 may be manufactured to have different thicknesses during manufacturing, the aluminum film 21 having an appropriate thickness may be used according to heat transferred through the headliner varying according to a vehicle type.

Additionally, the aluminum films 21 in which the adhesives are attached to surfaces thereof may be used. As in FIG. 3, this is to manufacture the headliner by integrally attaching the polyurethane foam sheet 10 and the non-woven fabrics 20 using the adhesives of the aluminum films 21 by applying an appropriate heat and pressure using a thermoforming mold or the like in a state in which the non-woven fabrics 20 and a skin member 30 are disposed on both sides of the polyurethane foam sheet 10.

In addition, an example of the aluminum films 21 that are disposed on both surfaces of the polyurethane foam sheet 10 and integrally formed with the polyurethane foam sheet 10 is shown in FIG. 3. However, the aluminum film 21 may be disposed on only any one of both surfaces of the polyurethane foam sheet 10 to manufacture the headliner. This is to allow the number of aluminum films 21 to be selected and used so as to obtain a sufficient heat insulating effect in consideration of the amount of heat transferred.

### C. Skin Member

The skin member 30 is mounted on a surface, which is exposed to the vehicle interior, of the polyurethane foam sheet 10 to which the non-woven fabrics 20 are attached to both sides thereof as in FIG. 3. In this case, since the skin member 30 is a surface exposed to the vehicle interior, a skin member manufactured through the conventional technology used in the technical field according to the present invention, such as a fabric capable of performing a finishing function may be used as the skin member 30.

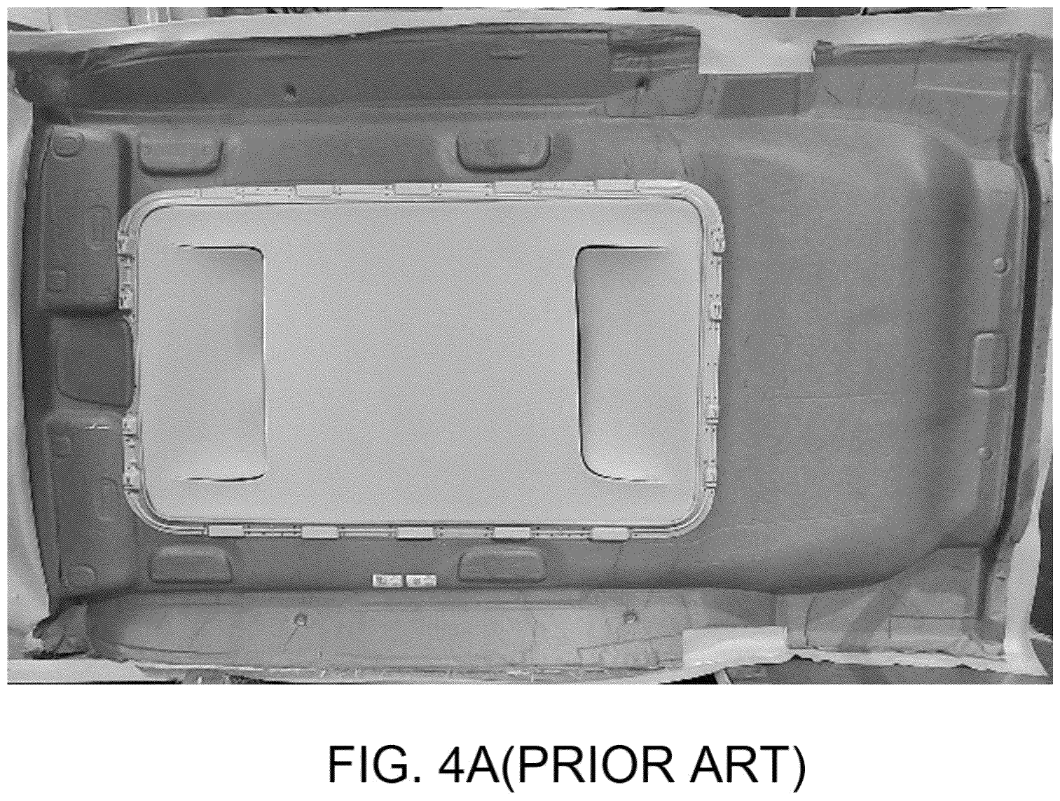

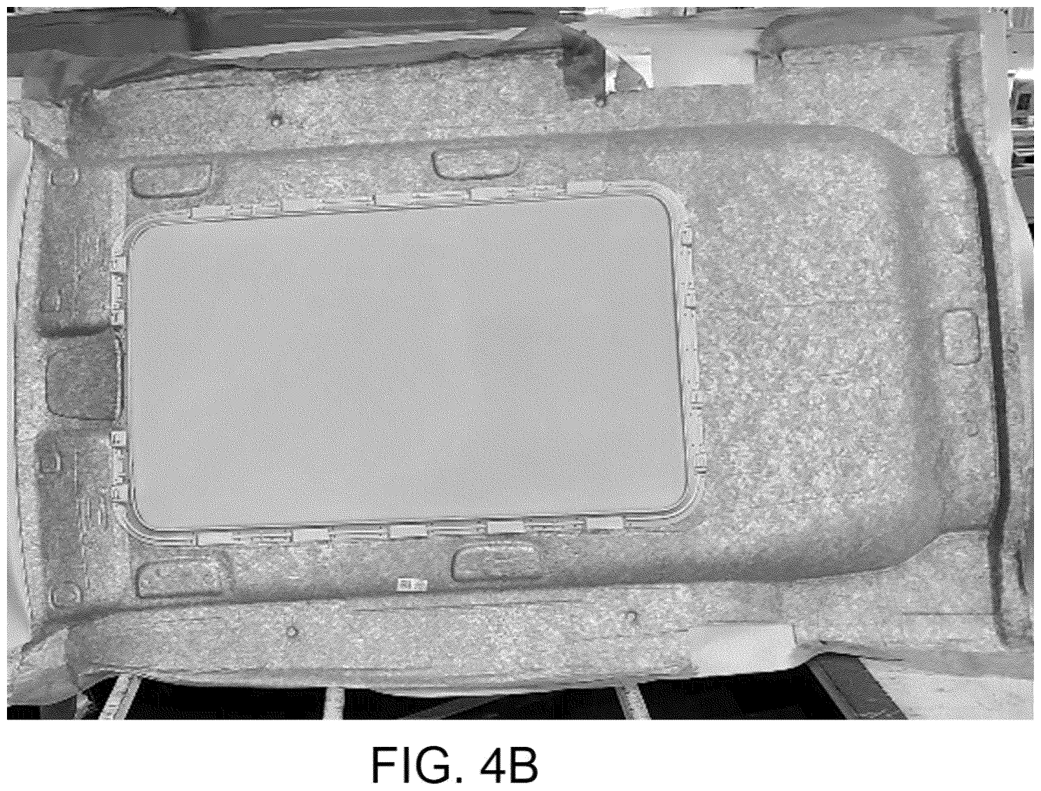

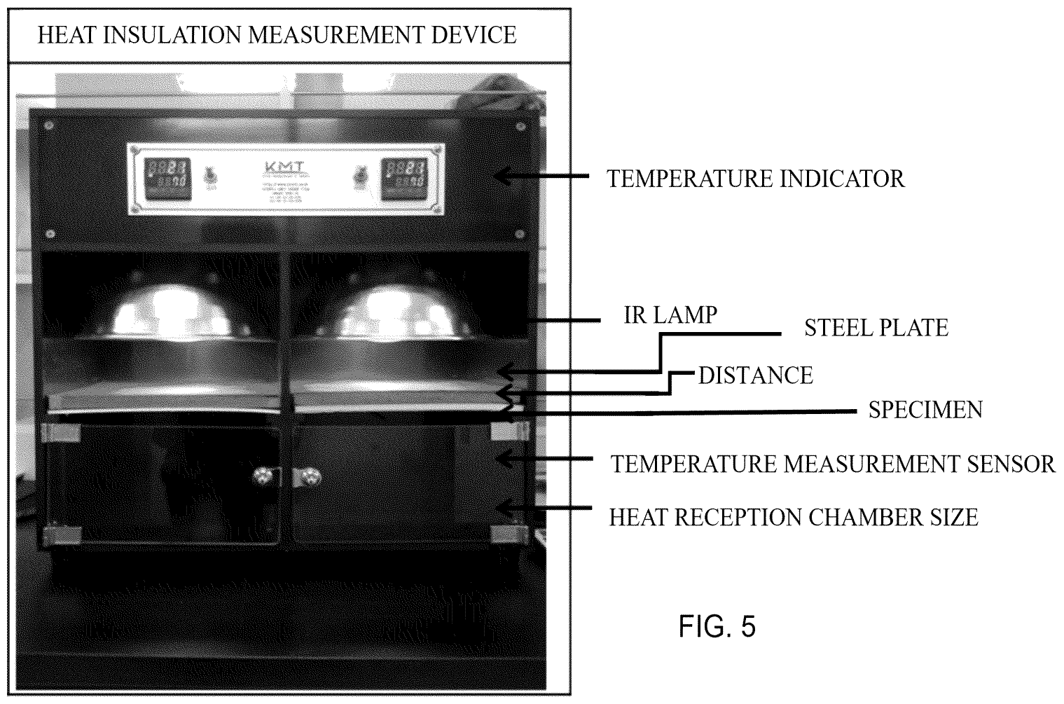

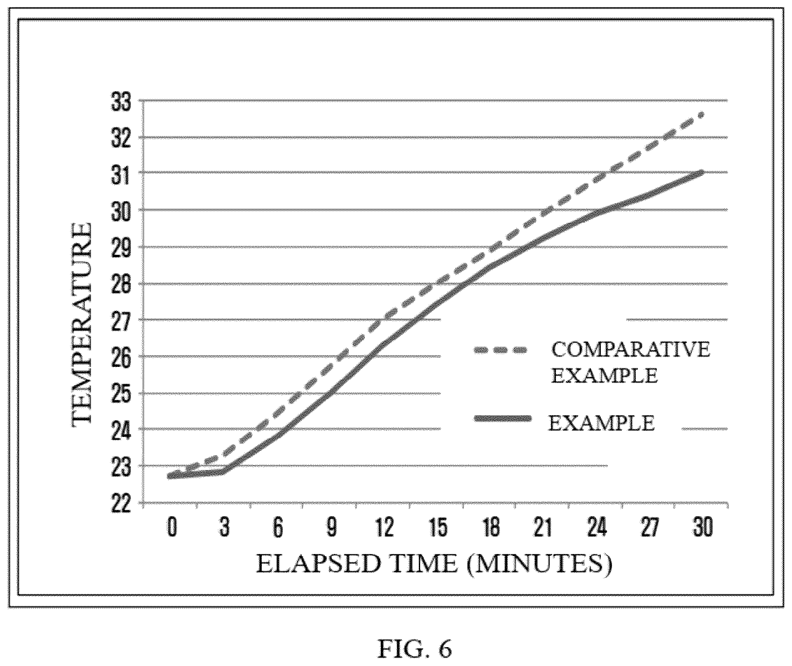

A result of measuring changes in temperature over time for Example formed as described above according to the present invention and Comparative Example using a hot melt without using an aluminum film is shown as in FIGS. 4 to 6 below. In this case, FIG. 4A shows an image of Example manufactured according to the present invention, and FIG. 4B shows an image of Comparative Example. FIG. 5 shows a measurement device for measuring heat insulations of Example and Comparative Example. In addition, in FIG. 6, a horizontal axis represents a time (minutes), a vertical axis represents a temperature (° C.), a broken line represents a temperature graph of Comparative Example, and a gray line represents a temperature graph of Example.

In the result shown in FIG. 6, it can be seen that Example according to the present invention has a higher heat insulating effect than Comparison Example over time and maintains a lower temperature. A difference in average temperature obtained due to the heat insulating effect was about 1.6° C.

A vehicle headliner having a heat insulating function according to the present invention has the following effects.

(1) Since a headliner into which an aluminum film formed of aluminum having a heat insulating effect is inserted is manufactured, the headliner having a heat insulating function according to the present invention can lower a temperature of a vehicle interior.

(2) In this case, the headliner according to the present invention forms a comfortable environment of the vehicle interior by lowering a temperature by about 1.6° ° C. as compared to when using a hot melt film while manufacturing the existing headliner.

(3) In particular, since the weight of an aluminum film is not high, an increase in total weight of the headliner can be minimized compared to when a non-woven fabric is attached to a polyurethane foam using the existing hot melt.

(4) Accordingly, since the aluminum film is used instead of the hot melt, the increase in total weight of the headliner can be minimized, or the heat insulating function can be obtained without increasing the weight.

(5) In this case, since the aluminum film coated with an adhesive is used, in addition to the heat insulating effect, an adhesive function that integrally attaches a polyurethane foam sheet and a non-woven fabric can also be obtained.

(6) Meanwhile, as the aluminum film is provided on at least one of both surfaces of the polyurethane foam sheet, the insertion number of aluminum films can be determined according to a degree of insulating heat being transferred to the vehicle interior.

What is claimed is:

1. A vehicle headliner having a heat insulating function, comprising:
non-woven fabrics (20) integrally attached to both surfaces of a polyurethane foam sheet (10);
a skin member (30) attached to and integrally formed with any one of the non-woven fabrics (20) that is attached to a surface exposed to an interior; and
aluminum films (21) inserted between and integrally attached to the polyurethane foam sheet (10) and the non-woven fabrics (20).

2. The vehicle headliner of claim 1, wherein each of the aluminum films (21) is coated with an adhesive.

3. The vehicle headliner of claim 1 or 2, wherein the aluminum film (21) is disposed on at least one surface of both surfaces of the polyurethane foam sheet (10) and integrally formed with the polyurethane foam sheet (10).
